(19) United States
(12) Patent Application Publication
(10) Pub. No.: US 2021/0368311 A1
(43) Pub. Date: Nov. 25, 2021

(54) METHOD FOR MAINTAINING A WIRELESS CONNECTION BETWEEN A VEHICLE AND AN INFRASTRUCTURE

(71) Applicant: RENAULT s.a.s., Boulogne-Billancourt (FR)

(72) Inventor: Eric PERRAUD, Plaisance du Touch (FR)

(73) Assignee: RENAULT s.a.s., Boulogne-Billancourt (FR)

(21) Appl. No.: 16/962,589

(22) PCT Filed: Dec. 18, 2018
(86) PCT No.: PCT/EP2018/085653

§ 371 Date: Jul. 16, 2020

(30) Foreign Application Priority Data
Jan. 18, 2018 (FR) 1850393

(51) Int. Cl. H04W 4/44; H04W 40/20

(52) U.S. Cl. CPC H04W 4/44; H04W 84/12; H04W 40/20

(57) ABSTRACT

A method maintains a wireless connection between a vehicle and infrastructure on a route along which there are local communication networks allowing communication between the vehicle and the infrastructure. The vehicle is initially located within the coverage area of a first local communication network, the vehicle is identified by a first identification element, and the vehicle communicates with the infrastructure via a first communication port. The method includes: determining a second local communication network covering a subsequent route section; generating a second identification element associated with the second local communication network; allocating at least one second communication port for establishing data transmission between the vehicle and the infrastructure within the coverage area of the second local communication network; and, when the vehicle enters the coverage area of the second local communication network, establishing communication between the vehicle and infrastructure via the second communication port, using the second identification element.

### TECHNICAL FIELD OF THE INVENTION

The present invention generally relates to inter-vehicle communication systems, generally referred to as “V2X”.

It relates more particularly to a method for maintaining a wireless connection between a vehicle and an infrastructure on a route along which there are local area communication networks that allow communication to be established between the vehicle and the infrastructure. It will be considered in this method that in the initial state, said vehicle:
is located within the coverage area of a first local area communication network,
is identified by this first local area communication network by a first identification element, and
communicates with the infrastructure via a first communication port.

It also relates to a device for maintaining a wireless connection between a vehicle and an infrastructure on a route along which there are local area communication networks that allow communication to be established between the vehicle and the infrastructure, said device comprising an item of user equipment suitable for exchanging data with the infrastructure, a means for determining the position of the vehicle, and a computer memory which stores a road map database and a radiofrequency and cellular infrastructure database.

### TECHNOLOGICAL BACKGROUND

The exchange of data between vehicles, in particular by virtue of the wireless communication systems referred to as “V2X”, is today an effective way of providing the driver with information and early warnings about their surroundings, especially concerning events occurring outside of their field of vision.

Two modes of communication between vehicles are known. The first mode, called PC5 (or “V2V”), is based on direct communication between vehicles. In this context, the vehicles are equipped with 4G modules and the communications take place under the control of 4G stations present in the vehicles' surroundings.

The second mode of communication, called Uu (or “V2I”) mode, is based on the transmission of data between vehicles via a mobile network communication infrastructure (or LTE for “Long-Term Evolution” according to the commonly used acronym). Specifically, a vehicle transmits a message to a server known as a “V2X” server via a communication port associated with an IP address linked to the vehicle. The “V2X” server redistributes the message locally to the vehicles present in the geographical area in question.

The Uu mode is particularly advantageous when it comes to transmitting, for example, an alert to all the vehicles present in a particular geographical area. However, communication interruptions may be observed, in particular during transitions in coverage from one mobile network to another or during transitions in coverage between two local area networks of the same mobile network.

Document WO2017126948 discloses a method for ensuring the continuity of the data transmission/reception service via a “V2X” connection during the transition from one network to another. For this, document WO2017126948 proposes the use of the PC5 mode of direct communication between vehicles during the network transition. Transmission is thus not interrupted. However, this method requires the presence of a 4G modem suitable for PC5 mode in all of the vehicles. In addition, during this transition period, messages transmitted directly between vehicles would not reach the level of the communication infrastructure. Relevant information, for example for traffic optimization, might then be lost.

### SUBJECT OF THE INVENTION

The present invention proposes improving the continuity of the data transmission/reception service via a “V2X” connection by guaranteeing that the connection is maintained during the transition from one local area communication network to another.

More particularly, what is proposed according to the invention is a method for maintaining a wireless connection between a vehicle and an infrastructure as defined in the introduction, the method comprising steps of:
determining at least one second local area communication network potentially covering a subsequent section of the route of the vehicle,
generating a second identification element of the vehicle associated with the second local area communication network,
allocating at least one second communication port for establishing data transmission between the vehicle and the infrastructure within the coverage area of the second local area communication network,
searching for the beginning of the coverage area of the second local area communication network, then
when the vehicle enters the coverage area of the second local area communication network, establishing communication between the vehicle and the infrastructure via the second communication port, using the second identification element.

Thus, by virtue of the present invention, the transition from one local area communication network to another is anticipated as the vehicle travels along its route. All of the elements allowing connection with the local area communication network covering the next section of the route are set up before the vehicle actually enters the coverage area of this local area network. Thus, when the vehicle actually passes into the coverage area of the second local area communication network covering the next section of the route, the connection between the vehicle and the infrastructure is not interrupted.

Other non-limiting and advantageous features of the maintaining method according to the invention, taken individually or in any technically feasible combination, are the following:
provision is made for a step of determining a time slot corresponding to a period in which the vehicle should reach the coverage area of the second local area communication network and a step of unassigning the second communication port if no data are transmitted by said second communication port in the determined time slot;
provision is made for a step of determining a time slot corresponding to a period in which the vehicle should reach the coverage area of the second local area communication network and a step of unassigning the first communication port if at least one item of data is transmitted by said second communication port in the determined time slot;
provision is made for a step of determining a time slot corresponding to a period in which the vehicle should reach the coverage area of the second local area communication network, a step of releasing a second resource allocated by the second local area communication network if no data are transmitted by said second communication port in the determined time slot and a step of releasing a first resource allocated by the first local area communication network if at least one item of data is transmitted by said second communication port in the determined time slot;
provision is also made in the method, in the step of determining the time slot, to use a road map database and/or a road conditions database and/or a traffic conditions database and/or a radiofrequency and cellular infrastructure database and/or a driving parameter associated with the vehicle and stored in a computer memory and/or data on the position and speed of said vehicle;
provision is also made in the method, in the step of determining the second local area communication network, to use a road map database and/or a road conditions database and/or a traffic conditions database and/or a radiofrequency and cellular infrastructure database and/or a driving parameter associated with the vehicle and stored in a computer memory and/or data on the position and speed of said vehicle;
provision is also made for a step of establishing a correspondence between the first identification element and the second identification element;
the first identification element corresponds to a first IP address and the second identification element corresponds to a second IP address;
provision is also made for the step of determining the second local area communication network to be performed within a server of the infrastructure;
provision is also made for the step of determining the second local area communication network to be performed within a computer of the vehicle; and
provision is also made, in the determining step, to determine a plurality of second local area communication networks potentially covering the second section of the route.

The invention also proposes a device for maintaining a wireless connection between a vehicle and an infrastructure as described in the introduction, wherein at least one data processing unit is provided that is suitable for implementing the following steps when said vehicle is initially located within the coverage area of a first local area communication network, it is identified by this first local area communication network by a first identification element, and it communicates with the infrastructure via a first communication port:
determining at least one second local area communication network potentially covering a subsequent section of the route of the vehicle,
generating a second identification element of the vehicle associated with the second local area communication network,
allocating at least one second communication port for establishing data transmission between the vehicle and the infrastructure within the coverage area of the second local area communication network,
searching for the beginning of the coverage area of the second local area communication network, then
when the vehicle enters the coverage area of the second local area communication network, establishing communication between the vehicle and the infrastructure via the second communication port, using the second identification element.

### DETAILED DESCRIPTION OF AN EXEMPLARY EMBODIMENT

The following description with reference to the appended drawings, which are provided by way of non-limiting examples, will aid in the understanding of the invention and how it may be embodied.

In the appended drawings:

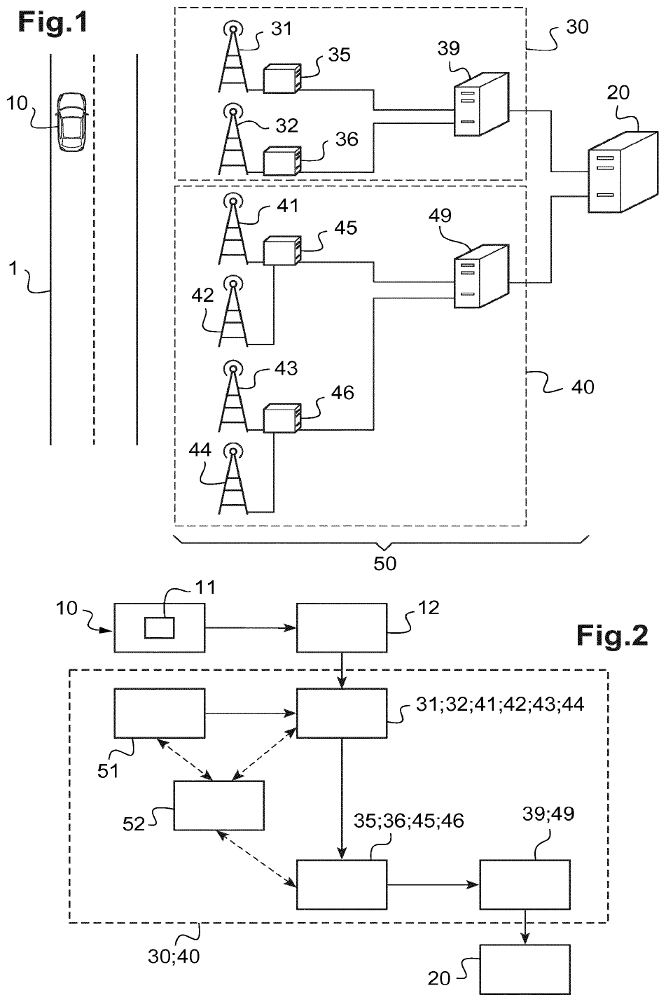

FIG. 1 is a schematic view of a motor vehicle connected to a wireless network;

FIG. 2 schematically shows the various entities employed in a method according to the invention;

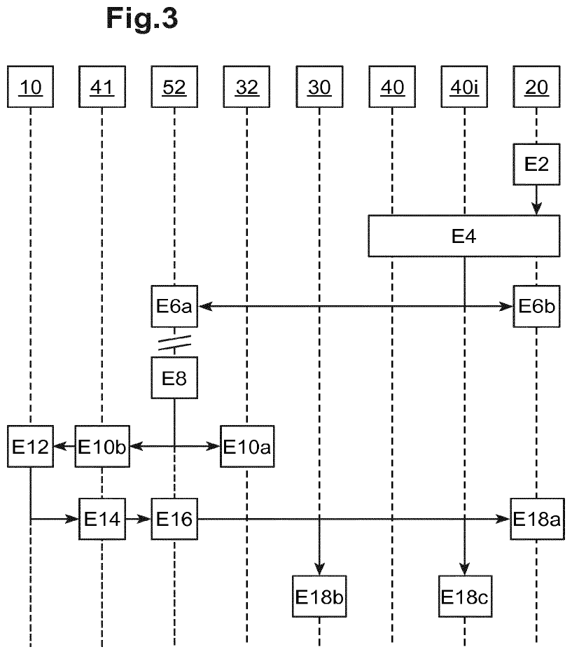

FIG. 3 is a flowchart showing a first example of the method according to the invention; and

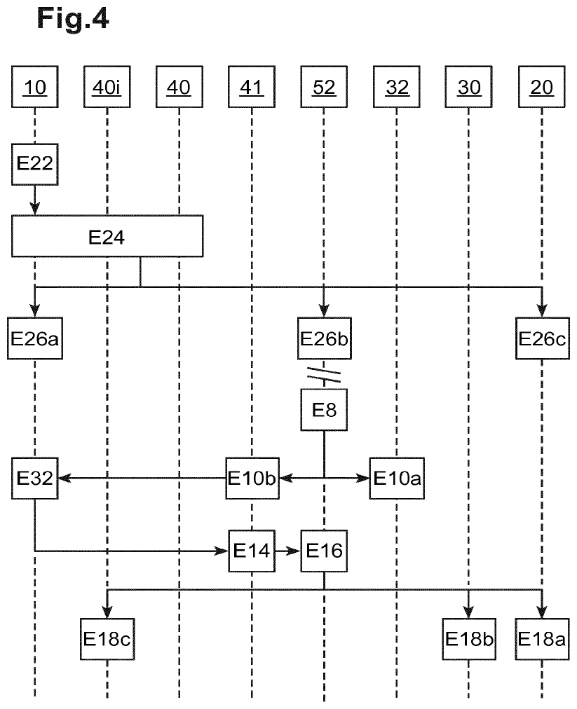

FIG. 4 is a flowchart showing a second example of the method according to the invention.

FIG. 1 shows a motor vehicle 10 driving along a road 1 in order to follow a determined route.

The network 50 is also shown along this road which allows the motor vehicle 10 to communicate with the outside, and in particular with an Internet server (hereinafter called V2X server 20).

This network 50 comprises in particular local area communication networks 30, 40 which link the area up. Two local area communication networks 30, 40 are shown here, one of which is located near the vehicle 10 and the other of which is located further along the route of the vehicle 10. In this situation, the vehicle 10 is located within the coverage area of the first local area communication network 30, but outside of that of the second local area communication network 40.

The exchange of data between vehicles via the use of this network 50 involves different entities that allow the transmission of data.

FIG. 2 schematically shows the various entities which are involved in the transmission of data and which are involved in the method of the invention described hereinafter.

In the context of this description, the data transmission relates to request data in order to establish an Internet connection with an infrastructure and/or information data relating, for example, to traffic conditions or relating to the vehicle.

The vehicle 10 comprises an item of user equipment 11. This item of user equipment 11 constitutes the entity allowing data to be transmitted (or received). In practice, it may for example be a cellphone, a smartphone, a touchscreen tablet or a laptop computer. It may also be a computer device integrated within the vehicle 10. The item of user equipment 11 is suitable for establishing a radiofrequency connection with a radio antenna 12.

The vehicle 10 (via the item of user equipment 11) is identified for this radiofrequency connection by a cell radio network temporary identity (or C-RNTI according to the commonly used acronym).

When the vehicle 10 has been identified, the radiofrequency link makes it possible to establish a connection between the item of user equipment 11 and a base station 31, 32, 41, 42, 43, 44 of the network 50.

The base station 31, 32, 41, 42, 43, 44 corresponds to an eNodeB station (for “Evolved Node B” according to the designation commonly used for the 4G network). This station provides access to the 4G network also called eUTRAN (for “Evolved Universal Terrestrial Radio Access Network”). This base station 31, 32, 41, 42, 43, 44 thus forms a bridge between the radio antenna 12 and the core of the network 51.

The core of the network 51 corresponds to the central portion of the 4G network. The various base stations 31, 32, 41, 42, 43, 44 are controlled by the core of the network 51.

Here, these base stations 31, 32, 41, 42, 43, 44 serve as intermediaries for establishing the connection with the external network without needing to go back to the core of the network 51 and to cross the entire network 51 core. This configuration makes it possible to optimize the latency criterion in the transmission of data to the V2X server.

The vehicle 10 is also identified at each base station 31, 32, 41, 42, 43, 44 by a cell radio network temporary identity (C-RNTI) specific to each base station 31, 32, 41, 42, 43, 44.

The core of the network 51 knows the vehicle 10 by a TMSI (for “Temporary Mobile Subscriber Identity”) identification number. This TMSI identification number is assigned by an MME (for “Mobility Management Entity”) controller 52. The TMSI identification number is allocated when the vehicle 10 is connected to the network 50. The MME controller 52 is suitable for managing the mobility of the vehicle 10 in the network 50. In particular, the MME controller 52 communicates, for example, information on change of base station 31, 32, 41, 42, 43, 44 to the vehicle 10.

As shown in FIGS. 1 and 2, the data from the item of user equipment 11 to the Internet network of an operator is then routed from the base station 31, 32, 41, 42, 43, 44 to a regional gateway 35, 36, 45, 46 (called SGW, or “serving gateway” according to the commonly used designation).

As shown in the example illustrated in FIG. 1, it is equally possible to provide one regional gateway 35, 36 per base station 31, 32, or a plurality of regional gateways 45, 46 per base station 41, 42, 43, 44.

As shown in FIG. 2, the regional gateway 35, 36, 45, 46 collects the data from the item of user equipment 11 and transmits said data to a PGW 39, 49 (for “packet gateway”).

The PGW entity 39, 49 constitutes, for an HLN local area communication network (called local area network 30, 40 in the remainder of this description), an entry gate to the Internet network which will then allow the routing of the data to the V2X server 20. The V2X server 20 thus corresponds to the infrastructure to which the vehicle 10 wishes to communicate data.

The V2X server 20 and the local area network 30, 40 know the vehicle 10 by an IP (for “Internet Protocol”) address. This IP address is allocated by the PGW entity 39, 49.

In summary, the vehicle 10 is identified by various identifiers (cell radio network temporary identity C-RNTI, TMSI number, IP address) depending on the entity in question. The MME controller 52 is suitable for establishing consistency between these various identifiers of the vehicle. For example, in a request to connect the vehicle to the V2X server 20, the TMSI number is inserted into the request message. The MME controller 52 can then establish a concordance relationship between the cell radio network temporary identity C-RNTI, the TMSI number and the IP address.

As shown in FIG. 1, the route of the vehicle 10 will be located within the coverage area of several local area networks 30, 40. The method of the invention proposes a method for maintaining the transmission of data between the vehicle 10 and the V2X server 20 when changing from one local area network 30, 40 to another (i.e. when the vehicle is moving along the route).

FIG. 3 shows a first embodiment of a method for maintaining the wireless connection between the vehicle 10 and the V2X server 20 on the route.

It is assumed that a connection has already been established between the vehicle 10 and the V2X server 20 via a first local area network 30. A first address IP₁ allows the vehicle 10 to be identified by the V2X server 20 and by the first local area network 30. During this connection session, the V2X server 20 receives in particular information on the location and speed of the vehicle 10 in real time (obtained by virtue of the presence of means for determining the speed and position of the vehicle 10, such as a wheel speed sensor and a GPS sensor).

In this first example, the V2X server 20 comprises a processing unit suitable for implementing the method in conjunction with the various entities involved in the method, in particular the base stations 31, 32, 41, 42, 43, 44, the MME controller 52 and the PGW entity 39, 49. As shown in FIG. 3, the method starts with step E2. In this step E2, the V2X server 20 identifies that the vehicle 10 will soon leave the coverage area of the first local area network 30.

This is realized for example using the geolocation of the vehicle 10 and a road map database which is coupled to a radiofrequency and cellular infrastructure database in order to show the various local area networks in a predetermined region (in Europe for example).

Following this realization, still in step E2, the V2X server 20 determines potential local area networks that may cover the next section of route.

To determine potential local area networks, the V2X server uses the road map database and the destination that the driver has entered into their user equipment 11. They may also use other data. For example, they may use a road conditions database and/or a traffic conditions database and/or a driving parameter associated with the vehicle and stored in a computer memory and/or data on the position and speed of said vehicle 10.

In the remainder of this description, these potential local area networks are denoted by 40ᵢ.

In step E4, the V2X server 20 transmits an instruction for pre-allocation of a new address IPᵢ to each potential local area network 40ᵢ (more specifically to each entity 49 of each potential local area network 40ᵢ). The V2X server 20 also transmits the first address IP₁ to each potential network 40ᵢ so that each potential network 40ᵢ can associate the first address IP₁ with each new address IPᵢ.

The V2X server 20 also determines, for each potential network 40ᵢ, a time slot corresponding to the period in which the vehicle 10 is likely to reach the coverage of the potential local area network 40ᵢ in question.

The earliest time at which the vehicle 10 might join the potential local area network 40ᵢ is denoted by t_{1,i}. The latest time at which the vehicle 10 might join the potential local area network 40ᵢ is denoted by t_{2,i}. The new address IPᵢ can be activated during the time slot [t_{1,i}; t_{2,i}].

These moments can be predetermined and invariable. However, preferably, they will be determined taking into account the geolocation of the vehicle 10 and the road map database coupled to the radio and cellular infrastructure database.

As shown in FIG. 3, in step E6a, each potential local area network 40ᵢ transmits the IP address IPᵢ to the MME controller 52. Since the new address IPᵢ and the first address IP₁ were associated in step E4, the MME controller 52 can ensure the consistency of the identifiers of the vehicle 10 by associating the cell radio network temporary identity C-RNTI and the TMSI number with the new address IPᵢ.

At the same time, in step E6b, each potential local area network 40ᵢ transmits each new address IPᵢ to the V2X server 20. For each new address IPᵢ, the V2X server 20 then pre-allocates a new communication port. This new communication port is provided to allow data transmission between the vehicle 10 and the V2X server 20 within the coverage area of the associated local area network 40ᵢ. The V2X server 20 also pre-allocates new resources, associated with each potential local area network 40ᵢ, which will be required to perform this data transmission. For example, they may be memory resources for storing the data to be transmitted to other vehicles.

The anticipatory creation of the tools required for the establishment of a connection within the coverage area of a new local area network then in general makes it possible to avoid the data transmission between the vehicle 10 and the V2X server 20 being interrupted.

The new communication port and the new resources can also be activated during the time slot [t_{1,i}; t_{2,i}]. In step E8, the MME controller 52 has identified that the vehicle 10 is entering the coverage area of a second local area network 40. This second local area network 40 was of one of the potential local area networks 40ᵢ identified in step E2 by the V2X server 20.

The MME controller 52 effects the local area network transition by triggering a handover between a first base station 32, associated with the first local area network 30, and a second base station 41, associated with the second local area network 40.

In this step E8, the MME controller 52 destroys the pairs associating the first address IP₁ with each new address IPᵢ, with the exception of the pair associating the first address IP₁ with the new address (denoted by IP₂) of the second local area network 40 (the one that the vehicle 10 has just entered).

In step E10a, the MME controller 52 sends, via the handover, the disconnect instruction to the first base station 32. Simultaneously, in step E10b, the MME controller 52 sends a connect instruction to the second base station 41. In this step E10b, the MME controller 52 also transmits the second address IP₂ (associated with all of the identifiers of the vehicle 10) to the first base station 32.

This handover (combination of steps E10a and E10b) is the only phase which may result in a possible connection interruption. However, this interruption is very short, being less than 50 ms. This interruption is much shorter than that related to the loss of the IP address which occurs in the wireless connection methods usually implemented.

The second base station 41 then sends, in step E12 and by virtue of the radiofrequency link, the second address IP₂ to the vehicle 10 in the protocol messages of the handover governing the transition from the first base station 32 to the second base station 41. The vehicle 10 can then update the connection settings allowing it to exchange data with the V2X server 20 within the coverage area of the second local area network 40.

In step E14, the vehicle 10 informs the second base station 41 of the successful completion of the handover and the updating of the connection elements.

The second base station 41 transmits this information to the MME controller 25 in step E16. The MME 52 controller confirms the use of the second address IP₂ for connection to the V2X server 20.

In step E18a, data are received by the V2X server 20 from the vehicle 10 via the new connection established (within the coverage area of the second local area network 40) and the use of the second communication port. These data are received by the V2X server 20 during the time slot [t_{1,2}; t_{2,2}].

The reception of these data by the V2X server 20 results in the first communication port being unassigned (step E18b). Since this first communication port was associated with the coverage area of the first local area network 30, it will not receive data to be transmitted within the coverage area of the second local area network 40. This also results in the release of the resources allocated for the transmission of data by the first local area network 30.

The reception of these data by the V2X server 20 from the second communication port also results, in step E18c, in the communication ports associated with the potential local area networks 40ᵢ other than the second local area network 40 being unassigned (which will therefore not receive no data during the time slot [t_{1,i}; t_{2,1}] because they did not correspond to the local area networks actually covering the section of the route of the vehicle 10). This also results in the release of the resources allocated for the transmission of data by these potential local area networks 40ᵢ.

Once the V2X server 20 has received the new data from the vehicle 10, for example in the case of information on traffic along the route of the vehicle 10, the V2X server can trigger the transmission of these data to the other vehicles present in the geographical region in question.

FIG. 4 shows a second example of the method according to the invention. The steps common to FIGS. 3 and 4 bear the same references and will not be described again below.

As for the example proposed in FIG. 3, it is assumed that a connection has already been established between the vehicle 10 and the V2X server 20 via a first local area network 30. A first address IP₁ allows the vehicle to be identified by the V2X server 20 and the first local area network 30.

According to FIG. 4, the method starts at step E22. In this step E22, a computer of the vehicle 10 identifies that the vehicle will soon leave the coverage area of the first local area network 30. This computer constitutes the processing unit suitable for implementing this second example of the method.

The change in network coverage is here again realized using the geolocation of the vehicle 10 and a road map database which is coupled to a radiofrequency and cellular infrastructure database showing the various local area networks in a predetermined region (in Europe for example). These databases may be embedded in the computer of the vehicle 10 or may be stored elsewhere, for example in the V2X server 20.

Following this realization, the computer of the vehicle 10 determines potential local area networks that can cover the next section of route. To determine the potential local area networks 40ᵢ, the computer of the vehicle 10 uses the same databases.

In step E24, the vehicle 10 transmits an instruction for pre-allocation of a new address IPᵢ to each potential local area network 40ᵢ (more specifically to each PGW entity 49 of each potential local area network 40ᵢ). The vehicle 10 also transmits the first address IPᵢ to each potential network 40ᵢ so that each potential network 40ᵢ can associate the first address IP₁ with the corresponding new address IPᵢ.

The computer of the vehicle 10 also determines, for each potential network 40ᵢ, a time slot [t_{1,i}; t_{2,i}] corresponding to the period in which the vehicle 10 is likely to reach the coverage area of the potential local area network 40ᵢ in question.

As shown in FIG. 4, in step E26a, each potential local area network 40ᵢ transmits the pre-allocated new address IPᵢ to the computer of the vehicle.

At the same time, in step E26b, each potential local area network 40ᵢ transmits the new address IPᵢ to the MME controller 52. Since the new address IPᵢ and the first address IP₁ were associated in step E24, the MME controller 52 can ensure the consistency of the identifiers of the vehicle 10 by associating the cell radio network temporary identity C-RNTI and the TMSI number with the new address IPᵢ.

Again at the same time, in step E26c, each potential local area network 40ᵢ transmits each new address IPᵢ to the V2X server 20. For each new address IPᵢ, the V2X server 20 then pre-allocates a new communication port and new resources associated with each potential local area network 40ᵢ.

The method continues through steps E8 to E10b which are similar to those presented in the example of FIG. 3.

Then, in step E32, the vehicle 10 receives the handover information and updates the second address IP₂ in the settings for connection to the V2X server 20.

The method continues again through steps E14 to E18c which are also similar to those presented in the example of FIG. 3.

The example of FIG. 4 has the advantage of not being implemented in the V2X server 20 since everything is controlled from the vehicle 10. However, the determination of potential local area networks is less accurate because the computer of the vehicle is not able to predict change in traffic in the short term. In addition, the implementation of the method according to the invention in the computer of the vehicle is more complex because it requires that the computer be able to acquire the mesh of the cellular infrastructure.

This invention ensures the IP continuity of V2X connectivity with a V2X server 20 by anticipating the change from one 4G local area network 30 to another 4G local area network 40 by pre-reserving the IP address on this new local area network for a limited time, the anticipation being made possible in particular by the knowledge of the route of the vehicle. These dynamic reservations are therefore independent of the radio technology, a single radio technology being used (in the preferred embodiment the radio technology used being 4G) but are related to the mobility of the vehicle 10. This method for maintaining a wireless connection between the vehicle 10 and the server 20 on a route along which there are local area communication networks 30, 40 that are connected to said server allowing communication to be established between the vehicle 10 and the server 20, the vehicle 10 being initially located within the coverage area of a first local area communication network 30, the vehicle being identified by this first local area communication network via an IP address IP₁, and the vehicle 10 communicating with the server 20 via a first communication port, comprises steps of:
determining at least one second local area communication network 40 potentially covering a subsequent section of the route of the vehicle,
provisionally pre-reserving an IP address IP_{2,i} of the vehicle 10 on each local area communication network potentially covering a following section of the route of the vehicle 40,
temporarily allocating at least one second communication port for each local area communication network 40 potentially covering a subsequent section of the route of the vehicle and suitable for establishing a data transmission between the vehicle 10 and the server 20 within the coverage area of each local area network communication 40,
searching for the beginning of coverage of the second local area communication network 40 and identifying the new local area communication network 40 from among the previously determined local area communication networks 40, then
as the vehicle 10 enters the coverage area of the second local area communication network 40, establishing communication between the vehicle 10 and the server 20 via the second communication port which has been temporarily allocated for the new local area communication network, by using the IP address which has been pre-reserved IP_{2,i} on this local area communication network 40 and by communicating this address IP_{2,i} to the vehicle, which becomes the new IP address of the vehicle.

The step of determining at least one second local area communication network 40 potentially covering a subsequent section of the route of the vehicle is performed:
either without knowing the route of the vehicle, the second local area networks 40 are for example those which correspond to the base stations neighboring that where the driver's vehicle is located
or by knowing the route of the vehicle, the second local area networks 40 are for example those which correspond both to base stations neighboring that where the driver's vehicle is located and to those which cover the route of the vehicle by using in particular a radiofrequency and cellular infrastructure database.

If the step of determining at least one second local area communication network 40 is performed within a server of the infrastructure 20, the step of pre-reserving the IP address and of pre-allocating a communication port for each second local area communication network is initiated by this server 20 and as the vehicle 10 passes into the coverage area of the second local area network, the new IP address of the vehicle is communicated to the vehicle by a signaling message of the wireless technology used (and in particular using a handover message if the wireless technology is a cellular technology). Alternatively, if the step of determining at least one second local area communication network 40 is performed within the computer of the vehicle 10, the step of pre-reserving the IP address and of pre-allocating a communication port for each second local area communication network 40 is triggered by the vehicle 10 by virtue of an IP tunnel that the vehicle has established with each second local area communication network, the portal of each local area network notifying the vehicle of the pre-reserved address on this local area network and, as the vehicle passes into the coverage area of the second local area network 40, the vehicle 10 uses the IP address that has been pre-reserved by this second local area network 40.

1-12. (canceled)

13. A method for maintaining a wireless connection between a vehicle and an infrastructure on a route along which there are local area communication networks that allow communication to be established between the vehicle and the infrastructure, said vehicle being initially located within the coverage area of a first local area communication network, the vehicle being identified by this first local area communication network by a first identification element, and the vehicle communicating with the infrastructure via a first communication port, the method comprising:
determining at least one second local area communication network potentially covering a subsequent section of the route of the vehicle;
generating a second identification element of the vehicle associated with the second local area communication network;
allocating at least one second communication port for establishing data transmission between the vehicle and the infrastructure within the coverage area of the second local area communication network;
searching for the beginning of the coverage area of the second local area communication network; then
establishing, when the vehicle enters the coverage area of the second local area communication network, communication between the vehicle and the infrastructure via the second communication port, using the second identification element.

14. The maintaining method as claimed in claim 13, further comprising:
determining a time slot corresponding to a period in which the vehicle should reach the coverage area of the second local area communication network; and
unassigning the second communication port when no data are transmitted by said second communication port in the determined time slot.

15. The maintaining method as claimed in claim 13, further comprising:
determining a time slot corresponding to a period in which the vehicle should reach the coverage area of the second local area communication network; and
unassigning the first communication port when at least one item of data is transmitted by said second communication port in the determined time slot.

16. The maintaining method as claimed in claim 13, further comprising:
determining a time slot corresponding to a period in which the vehicle should reach the coverage area of the second local area communication network;
releasing a second resource allocated by the second local area communication network when no data are transmitted by said second communication port in the determined time slot; or
releasing a first resource allocated by the first local area communication network when at least one item of data is transmitted by said second communication port in the determined time slot.

17. The maintaining method as claimed in claim 14, wherein the determining the time slot uses at least one of a road map database, a road conditions database, a traffic conditions database, a radiofrequency and cellular infrastructure database, a driving parameter associated with the vehicle and stored in a computer memory, and data on the position and speed of said vehicle.

18. The maintaining method as claimed in claim 13, wherein the determining the second local area communication network uses at least one of a road map database, a road conditions database, a traffic conditions database, a radiofrequency and cellular infrastructure database, a driving parameter associated with the vehicle and stored in a computer memory, and data on the position and speed of said vehicle.

19. The maintaining method as claimed in claim 13, further comprising:
establishing a correspondence between the first identification element and the second identification element.

20. The maintaining method as claimed in claim 13, wherein the first identification element corresponds to a first IP address and the second identification element corresponds to a second IP address.

21. The maintaining method as claimed in claim 13, wherein the determining the second local area communication network is performed within a server of the infrastructure.

22. The maintaining method as claimed in claim 13, wherein the determining the second local area communication network is performed within a computer of the vehicle.

23. The maintaining method as claimed in claim 13, wherein the determining includes determining a plurality of second local area communication networks potentially covering the second section of the route.

24. A device for maintaining a wireless connection between a vehicle and an infrastructure on a route along which there are local area communication networks that allow communication to be established between the vehicle and the infrastructure, said device comprising:
an item of user equipment configured to exchange data with the infrastructure;
means for determining the position of the vehicle;
a computer memory which stores a road map database and a radiofrequency and cellular infrastructure database; and
at least one data processing unit that is configured to implement the following steps when said vehicle is initially located within the coverage area of a first local area communication network, the vehicle is identified by the first local area communication network by a first identification element, and the communicates with the infrastructure via a first communication port:
determine at least one second local area communication network potentially covering a subsequent section of the route of the vehicle,
generate a second identification element of the vehicle associated with the second local area communication network, and
allocate at least one second communication port for establishing data transmission between the vehicle and the infrastructure within the coverage area of the second local area communication network,
searching for the beginning of the coverage area of the second local area communication network, then
when the vehicle enters the coverage area of the second local area communication network, establish communication between the vehicle and the infrastructure via the second communication port, using the second identification element.
